(19) United States
(12) Patent Application Publication
(10) Pub. No.: US 2012/0096410 A1
(43) Pub. Date: Apr. 19, 2012

(54) Computing Devices And Articles Of Manufacture

(76) Inventor: David Lancaster, Derby, KS (US)

(21) Appl. No.: 12/905,365

(22) Filed: Oct. 15, 2010

(51) Int. Cl. G06F 3/048

(52) U.S. Cl. 715/854

(57) ABSTRACT

Computing devices, interfaces, articles of manufacture and methods of interacting with computing devices are described in some aspects of the disclosure. According to one aspect, a computing device includes a display configured to generate visual images, processing circuitry coupled with the display and configured to control the display to depict a graphical user interface which comprises a plurality of tiles of a first hierarchical level, to access user input selecting one of the tiles of the first hierarchical level which are displayed in the graphical user interface, and to control the display to depict the graphical user interface comprising a plurality of tiles of a second hierarchical level which are associated with the selected one of the tiles of the first hierarchical level as a result of the accessed user input selecting the one of the tiles of the first hierarchical level, and wherein a plurality of different data items are associated with individual ones of the tiles of the second hierarchical level and wherein the processing circuitry is configured to control the computing device to convey data of one of the data items to a user of the computing device.

### TECHNICAL FIELD

Some aspects of this disclosure relate to computing devices, interfaces, articles of manufacture and methods of interacting with computing devices.

### BACKGROUND OF THE DISCLOSURE

It is commonplace for software programs to utilize graphical user interfaces (GUIs) to enable users to interact with the software. Such interfaces utilize menus, controls and toolbars, for example, to present an attractive interface to the user which may be interacted with by the user to control various operations of their computer.

In some arrangements, an input device, such as a mouse or keyboard, may be manipulated by a user for interact with the graphical user interfaces. In other embodiments, graphical user interfaces may be depicted using touch screens where users' fingers may interact directly with elements of the graphical user interfaces. More recently, these user interfaces have been incorporated into many different types of devices including smart phones, portable media devices, etc.

At least some aspects of the present disclosure are directed towards user interface methods and apparatus which facilitate the organization, retrieval, storage and/or communication of information. Other aspects are described herein from the following figures and description.

### BRIEF DESCRIPTION OF THE DRAWINGS

Exemplary embodiments of the disclosure are described below with reference to the following accompanying drawings.

FIG. 1 is a functional block diagram of a computing device according to one embodiment.

FIG. 2 is a functional block diagram of a computing device implementing external communications according to one embodiment.

FIG. 3 is an illustrative representation of a first hierarchical level of a graphical user interface according to one embodiment.

FIG. 4 is an illustrative representation of a second hierarchical level of a graphical user interface according to one embodiment.

FIG. 5 is an illustrative representation of a data view interface of a graphical user interface according to one embodiment.

FIG. 6 is an illustrative representation of an add data interface of a graphical user interface according to one embodiment.

FIG. 7 is an illustrative representation of a plurality of data type icons of a graphical user interface according to one embodiment.

FIG. 8 is an illustrative representation of an upload interface of a graphical user interface according to one embodiment.

FIG. 9 is an illustrative representation of a search interface of a graphical user interface according to one embodiment.

FIG. 10 is another illustrative representation of a second hierarchical level of a graphical user interface according to one embodiment.

FIG. 11 is another illustrative representation of a first hierarchical level of a graphical user interface according to one embodiment.

### DETAILED DESCRIPTION OF THE DISCLOSURE

This disclosure is submitted in furtherance of the constitutional purposes of the U.S. Patent Laws “to promote the progress of science and useful arts” (Article 1, Section 8).

According to one embodiment, a computing device comprises a display configured to generate visual images, processing circuitry coupled with the display and configured to control the display to depict a graphical user interface which comprises a plurality of tiles of a first hierarchical level, to access user input selecting one of the tiles of the first hierarchical level which are displayed in the graphical user interface, and to control the display to depict the graphical user interface comprising a plurality of tiles of a second hierarchical level which are associated with the selected one of the tiles of the first hierarchical level as a result of the accessed user input selecting the one of the tiles of the first hierarchical level, and wherein a plurality of different data items are associated with individual ones of the tiles of the second hierarchical level and wherein the processing circuitry is configured to control the computing device to convey data of one of the data items to a user of the computing device.

According to an additional embodiment, a computing device comprises a display configured to generate visual images, communications circuitry configured to implement communications externally of the computing device, processing circuitry coupled with the display and the communications circuitry, and wherein the processing circuitry is configured to control the display to depict a graphical user interface which comprises a plurality of tiles at a first hierarchical level, a plurality of tiles at a second hierarchical level which are associated with the tiles of the first hierarchical level, and a plurality of data items which are associated with the tiles of the second hierarchical level, and wherein the processing circuitry is configured to control the communications circuitry to communicate, externally of the computing device, one of the tiles of the first hierarchical level, the tiles of the second hierarchical level which are associated with the one of the tiles of the first hierarchical level, and the data items which are associated with the tiles of the second hierarchical level which are associated with the one of the tiles of the first hierarchical level.

According to another embodiment, an article of manufacture comprises computer-readable storage media storing programming configured to cause processing circuitry to perform processing comprising displaying a plurality of data type icons of a graphical user interface and which are indicative of different types of data items, as a result of user input, selecting one of the data type icons for a data item being created by a user, associating data inputted by a user with the data item being created, storing the data and the selected one of the data type icons of the data item, and displaying the data and the one of the data type icons of the data item as a result of the user selecting one of a plurality of tiles of the graphical user interface.

Some aspects of the disclosure are directed to methods and apparatus which generate graphical user interfaces to assist users with interaction with computing devices. At least one embodiment described below assists users with organization, retrieval, storage and/or communication of information using their respective computing devices. Example computing devices include communications devices (e.g., smartphones), media players (e.g., mp3 players), and computers (e.g., personal computers, notebook computers, work stations), and other processing devices which are configured to depict graphical user interfaces for user interaction with the respective devices.

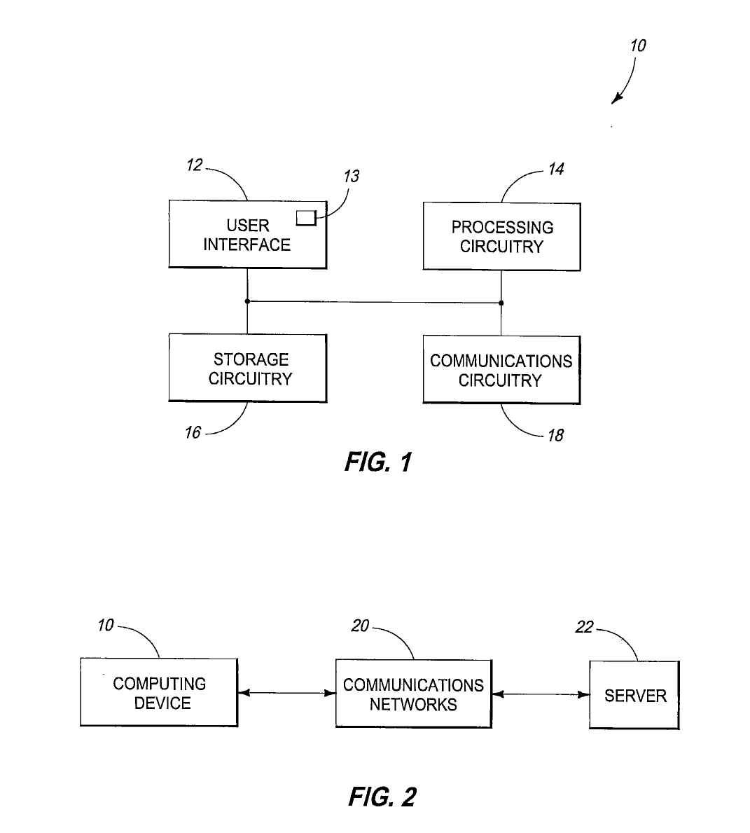

Referring to FIG. 1, one embodiment of a computing device 10 is illustrated. The example computing device 10 shown in FIG. 1 includes a user interface 12, processing circuitry 14, storage circuitry 16 and communications circuitry 18. The computing device 10 may be implemented in different configurations in other embodiments and may include more, less and/or alternative components. For example, if the computing device 10 is implemented as a smartphone, the computing device 10 may additionally include a microphone and speaker.

User interface 12 is configured to interact with a user including conveying data to a user (e.g., displaying visual images for observation by the user) and/or receiving inputs from the user. User interface 12 includes a display 13 which is configured as a graphical user interface (GUI) in one embodiment. A user may provide inputs to computing device 10 by contacting the graphical user interface of display 13 and/or via other input devices (e.g., keyboard, mouse, etc.) in example arrangements.

In one embodiment, processing circuitry 14 is arranged to process data, control data access and storage, issue commands, and control other desired operations. In one embodiment, processing circuitry 14 is configured to control the display 13 to depict images of a graphical user interface as well as to process user inputs.

Processing circuitry 14 may comprise circuitry configured to implement desired programming provided by appropriate computer-readable storage media in at least one embodiment. For example, the processing circuitry 14 may be implemented as one or more processor(s) and/or other structure configured to execute executable instructions including, for example, software and/or firmware instructions. Other exemplary embodiments of processing circuitry 14 include hardware logic, PGA, FPGA, ASIC, state machines, and/or other structures alone or in combination with one or more processor(s). These examples of processing circuitry 14 are for illustration and other configurations are possible.

Storage circuitry 16 is configured to store programming such as executable code or instructions (e.g., software and/or firmware), electronic data, databases, image data, or other digital information and may include computer-readable storage media. In some embodiments described herein, storage circuitry 16 is configured to store a plurality of data items and tiles which may be arranged in a database in a plurality of hierarchical levels of the graphical user interface as discussed herein. At least some embodiments or aspects described herein may be implemented using programming stored within one or more computer-readable storage medium of storage circuitry 16 and configured to control appropriate processing circuitry 14.

The computer-readable storage medium may be embodied in one or more articles of manufacture which can contain, store, or maintain programming, data and/or digital information for use by or in connection with an instruction execution system including processing circuitry 14 in the exemplary embodiment. For example, exemplary computer-readable storage media may include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

Communications circuitry 18 is arranged to implement communications of computing system 10 with respect to external devices (e.g., communications networks 20 of FIG. 2). For example, communications circuitry 18 may be arranged to communicate information bi-directionally with respect to computing system 10 and external devices and networks. Communications circuitry 18 may be implemented as a network interface card (NIC), serial or parallel connection, USB port, Firewire interface, flash memory interface, wireless communications circuitry (e.g., cellular), or any other suitable arrangement for implementing communications with respect to computing device 10. In one embodiment, communications circuitry 18 may be configured to implement telephone communications with telephone networks and/or Internet communications with respect to the Internet.

Referring to FIG. 2, computing device 10 may communicate with one or more communications network(s) 20 and server 22 via communications circuitry 18 of FIG. 1 in one embodiment. The communications networks 20 may include one or more appropriate network(s) for implementing communications between computing device 10, server 22 and other computing devices (not shown). In one implementation, communications network(s) 20 may include wired and/or wireless networks and implement telephone communications, cellular communications, Internet communications, data communications, email communications, text communications, etc.

A plurality of the computing devices 10 may access server 22 via one or more of the communications networks 20. Server 22 is configured to receive, store, and provide access to information of the users of the computing devices 10. As described further below, users can generate and organize information (e.g., using tiles, hierarchical arrangements, data items) using their computing device 10 and upload the information to the server 22 which stores the user's information within a database in one embodiment. Other users may access the server 22, search the stored information (e.g., information of other users) and download and view the information as described in additional detail below. In one embodiment, information uploaded by a user may be protected by a password which must be entered to enable other users to access the information. At least some aspects of the disclosure enable a user to integrate information from other user's into their own data organizational hierarchy described below.

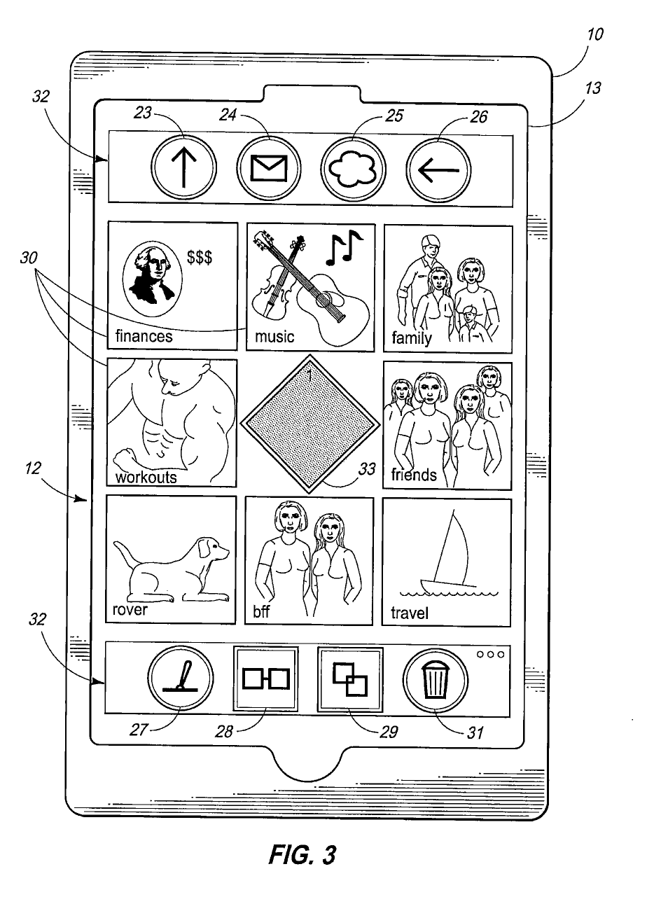

Referring to FIG. 3, one example embodiment of a user interface 12 which is implemented as a graphical user interface via display 13 of computing device 10 is shown. The described example of the graphical user interface allows a user to arrange data in a plurality of hierarchical levels. In one embodiment, the different hierarchical levels include a first level (e.g., shown in FIG. 3) where data is arranged by relatively general categories (or topics or genus) at the highest level or order, a second level or order where data is arranged by sub-categories (or sub-topics or sub-genus), a third level or order where data is arranged by sub-sub-categories (or sub-sub-categories or sub-sub-genus), etc. Different categories, sub-categories and sub-sub-categories may be individually associated with and represented by respective icons in the form of tiles 30 as discussed in further detail below according to one embodiment. FIG. 3 is a user's personal organization interface which includes their personal tiles 30 arranged in a grid in one example embodiment. Users may add, delete and reorganize tiles 30 as described below in one possible implementation. Furthermore, different types of data items (e.g., text, audio files, video files, etc.) may be associated with individual ones of the tiles.

In one configuration, the display 13 is configured to detect user inputs interacting with the graphical user interface of the display. For example, the display 13 is configured to detect a user's finger adjacent to a specific area of the display (e.g., selecting an area of display 13 which corresponds to one of the tiles 30).

In the example tiled-implementation of the graphical user interface shown in FIG. 3, the tiles 30 are arranged in a grid or array over a majority of the viewable display surface of the display 13 and which includes a plurality of rows and columns of the tiles 30 although the tiles 30 may also be arranged in a single row or column in other embodiments. In some embodiments, the tiles 30 do not overlap one another. In addition, different numbers of tiles 30 and different arrangements of tiles 30 may be provided in the interface 12 in other embodiments. For example, the array of tiles may include other tile arrangements, such as 2×2, 3×4, 4×4, or any other suitable arrangement of the tiles 30.

As mentioned previously, the graphical user interface includes a plurality of hierarchical levels which may be displayed at different moments in time using the display 13 in one embodiment. In this example, the tiles 30 which are displayed in FIG. 3 correspond to the same respective level. Additional levels may be displayed at other moments in time as a result of a user drilling up or down as described further below.

Tiles 30 may be individually associated with a category, sub-category, sub-sub-category, etc. in one of the different hierarchical levels. In the example of FIG. 3, a first hierarchical level is displayed and the tiles 30 correspond to respective different categories, such as finances, music, family, workouts, etc. An individual tile 30 may include a graphical image and/or text which correspond to the respective category of the tile 30 and which may be useful to a user to identify the categories of the tiles 30 in one embodiment. In one embodiment, a user may draw an illustrative representation (e.g., doodle art) which is to be used as the image for a tile 30 and assign the illustration to the appropriate 30 tile.

Furthermore, the graphical user interface includes a control tile 33 in the depicted embodiment. The control tile 33 is positioned in the middle of the array in the illustrated example arrangement although it may be positioned in other locations in other embodiments. The control tile 33 may also be distinguished from the category tiles 30, for example, in the shape of a diamond as opposed to including a graphical image.

The user may select the control tile 33 to drill up through the hierarchical levels in one embodiment as discussed in further detail below. Additionally, the control tile 33 may include indicia which identifies the respective hierarchical level which is currently being depicted via the display 13 (e.g., “level 1” in the depicted example of FIG. 3). The control tile 33 may be omitted in some embodiments and replaced with another tile 30 corresponding to a category, subcategory, etc. of the appropriate hierarchical level.

The GUI of computing device 10 also includes a plurality of control icons 32 in the illustrated embodiment. The control icons 32 enable the user to control various functions with respect to the tiles 30 as described in further detail below.

As discussed above, one embodiment of the GUI enables a user to drill up and down with respect to the plurality of hierarchical levels. FIG. 3 illustrates a first or top level of the hierarchical arrangement which includes a plurality of tiles 30 which correspond to a plurality of different categories in the described embodiment. A user may drill down into a specific one of the categories by selecting a respective one of the tiles 30.

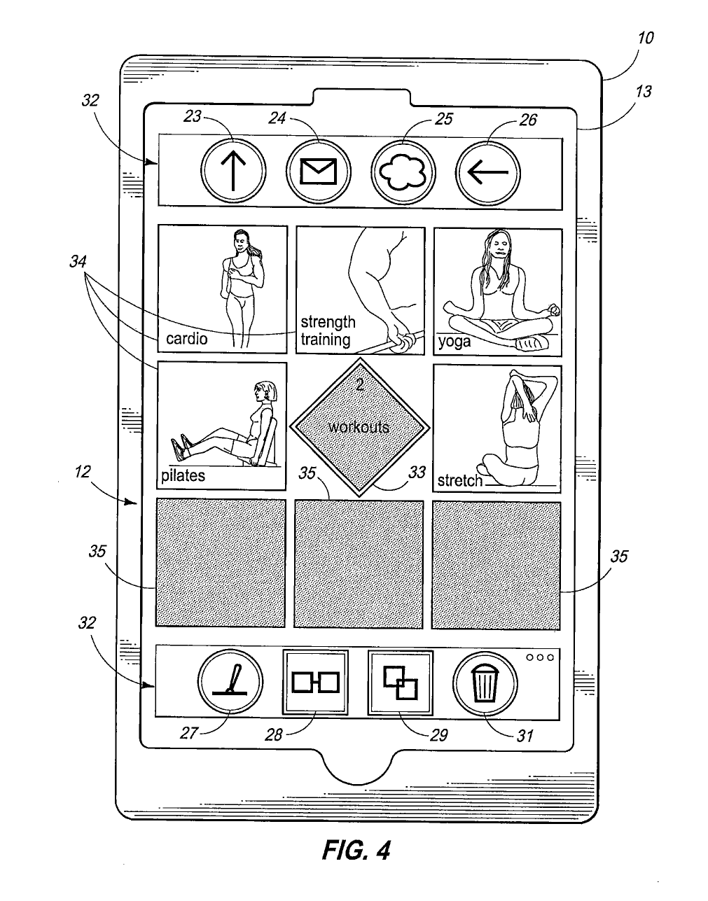

In one example of drilling down with reference to FIG. 4, the user has selected or opened the “workouts” category tile 30 of FIG. 3 which results in the display 13 depicting a plurality of tiles 34 of a second hierarchical level which correspond to sub-categories of the “workouts” category. As shown, the control tile 33 now includes indicia which indicates the current hierarchical level being depicted as level 2 corresponding to the sub-category hierarchical level, and which also indicates the category “workouts” which was previously selected. In one embodiment, the image which was associated with the category tile 30 which was selected in level 1 may become the background wallpaper of the display 13 behind the icons 32 and tiles 33, 34 although such is not shown in FIG. 4 for clarity. Furthermore, a user may drill down into a specific one of the sub-categories by selecting a respective one of the sub-category tiles 34 which would result in the generation of a user interface including tiles of a third hierarchical level (i.e., sub-sub-category level).

Furthermore, a user may desire drill up to one or more higher hierarchical levels. For example, the user viewing one of the hierarchical levels may select the control tile 33 to drill up to one or more higher hierarchical levels above the currently viewed level. Icons 23, 26 may also be utilized to navigate between different levels of tiles. In one embodiment, icon 23 may be selected to return a user to the first (top) hierarchical level or icon 26 may be selected to navigate to the next higher hierarchical level than the currently displayed hierarchical level. Tile 27 may be utilized by the user to toggle between inclusion or omission of text on the tiles 30 in one embodiment.

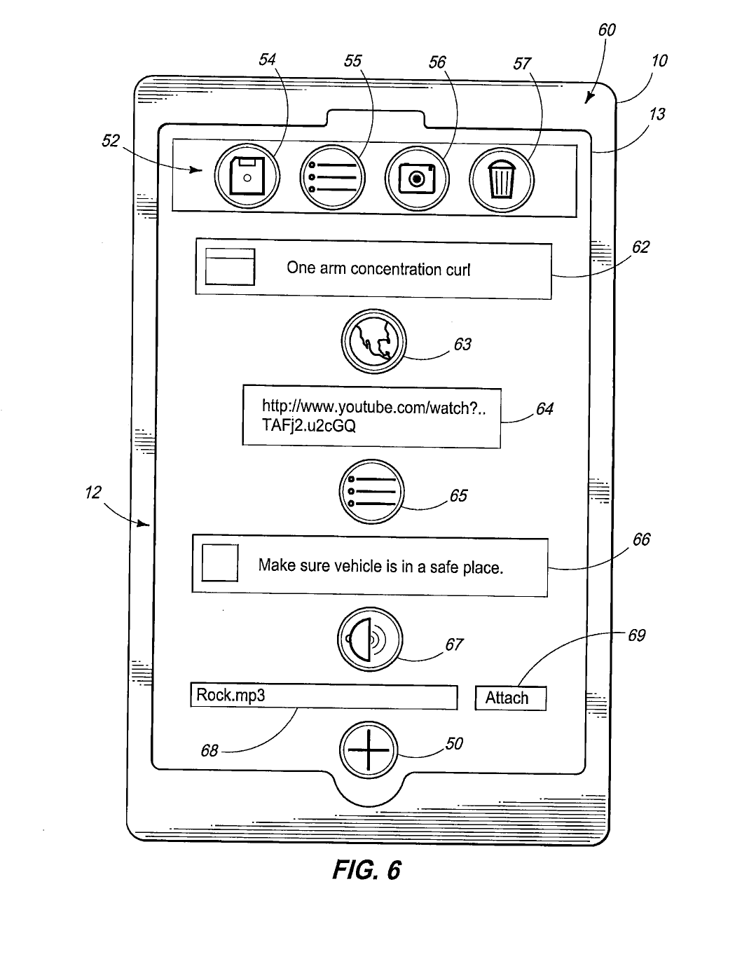

The hierarchical levels may include one or more blank tiles which may be utilized by the user in the future. For example, the second hierarchical level shown in FIG. 4 has three blank tiles 35. The user may define the topics for the blank tiles 35 and associate sub-ordinate tiles (i.e., tiles of a lower level or order) and data items with the blank tiles 35 as described further below with respect to the example FIG. 6.

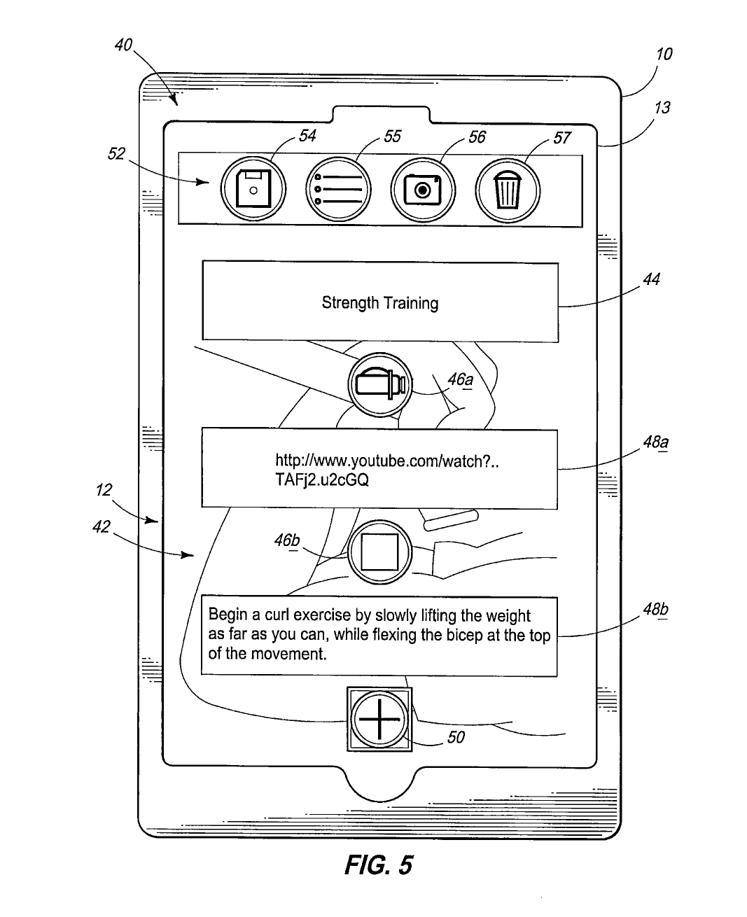

Referring to FIG. 5, the user has selected or opened the “strength training” sub-category tile 34 of FIG. 4 which results in the display 13 depicting a data view interface 40 at the third hierarchical level and which corresponds to the “strength training” sub-category. The interface 40 illustrates an image 42 in the background wallpaper which corresponds to the selected sub-category in one embodiment.

The data view interface 40 is the lowest level provided in the hierarchical arrangement of the “strength training” category in the described embodiment as the user has not defined any sub-sub-categories associated with the “strength training” sub-category. As discussed in additional detail below, a user may associate a plurality of data items with the lowest level or order tiles of the hierarchical arrangement and which may be interacted with by the user.

In another example, the user may specify or organize the data of one or more sub-category according to one or more additional hierarchical levels and additional tiles may be associated with the additional levels. A user may have defined a plurality of sub-sub-categories for the “strength training” sub-category which would result in the interface depicting another interface similar to FIG. 4 but including a plurality of sub-sub-tiles corresponding to the sub-sub-categories if the “strength training” sub-category was selected by the user. The selection of one of the sub-sub-category tiles would result in the depiction of the above-described data view interface 40 if the sub-sub-category tile selected by the user was the lowest order of the hierarchical levels for the selected sub-sub-category. For example, under the “strength training” sub-category, the user may have defined one or more sub-sub-categories, for example, different exercises, such as “one arm concentration curl,” “squat,” “bench press,” etc. In this second example, the interface includes four hierarchical levels for the “strength training” sub-category with the data view interface 40 being presented as the lowest level of the data if the user selects a sub-sub-category tile.

The illustrated example data view interface 40 includes a title field 44 of the respective topic for the data view interface 40. The title field 44 may include the title of the respective tile 34 which was selected in the previous hierarchical level (e.g., the title would be “strength training” if there are no sub-ordinate tiles under the “strength training” sub-category tile 34 which was selected by the user).

The data view interface 40 also includes one or more data items which correspond to the current topic of the data view interface 40 being displayed in the depicted embodiment (e.g., corresponding to the respective tile selected by the user). The data items may include different data which is associated with the current topic and may be different types of data which may be conveyed to a user to be experienced by the user (e.g., audio data may be played by a speaker of the computing device, textual or video data may be displayed using a display 13, etc.).

Data item icons 46a, 46b and a plurality of respective data fields 48a, 48b may be provided for the respective data items in one embodiment. The icons 46 individually identify the type of data of the respective data item associated with the icon and the data fields 48 individually may include the data of the respective data item. In one implementation, the user may have previously defined the data item icons 46a, 46b and contents of the data fields 48a, 48b as described in further detail below. In addition, less or more data view items may be provided within a data view interface 40 for the lowest level of a topic in one implementation.

Users interact with the data item icons 46 in one embodiment. For example, data item icon 46a for the first data item is a video icon and the corresponding data field 48a for the data item includes a http link to a location where the video may be found. A user may select the data item icon 46a which initiates the computing device 10 to depict the video via the display 13 which is located at the http link set forth in the respective data field 48a in one embodiment.

Data item icon 46b corresponds to a text data item and the textual contents of the data item are shown in the respective data field 48b and which may be reviewed by the user in the illustrated embodiment.

In addition to videos and text, the user can also experience other types of data items using data view interface 40 as described further below. For example, users may define and utilize data items to initiate phone calls, review documents, look-up addresses, play audio recordings, or launch other programs or processes using the computing device 10, etc.

Accordingly, in one embodiment, selection of some of the data items (e.g., item 46a) may initiate additional operations of the computing device 10 once selected by the user, such as connecting with a website (e.g., connecting with http links), launching videos, launching audio recordings, launching programs (e.g., open a document associated with a tile using Adobe Reader or Word), etc. while other data items (e.g., 46b) include text in a respective data field (e.g., 48b) which may be viewed by the users (e.g., text boxes, lists, steps, etc.).

In the illustrated example, icon 46b and the respective data field 48b correspond to the last data item in the interface 40. An addition icon 50 is also displayed which a user may select and use to add additional data items to the data view interface 40 as discussed in further detail below, for example with respect to FIG. 6.

FIG. 5 also includes a plurality of control icons 52 including a save icon 54, default view icon 55, camera icon 56, and garbage icon 58. Once a user has completed defining or adding data items to the data view interface 40, the user may utilize the save icon 54 to save the data items of the data view interface 40 for subsequent retrieval and viewing when the tile of the next higher level which is associated with the interface 40 is selected by the user.

The default view icon 55 enables a user to specify that he wishes to view a default view of the data view interface 40 when the respective data view interface 40 is presented to the user in subsequent interactions following selection of the respective tile by the user. The illustrated data view interface 40 of FIG. 5 is the default view when the respective tile corresponding to the data view interface 40 was selected in one embodiment.

Alternatively, the user may select to have the data of one of the data items of the interface 40 automatically conveyed to the user when the respective tile is selected by the user (as opposed to presenting the data view interface 40 upon selection of the respective tile). In one embodiment, a user may select the camera icon 56 while viewing interface 40 whereupon the computing device 10 may depict a list of the data items which have been associated with the data view interface 40 (e.g., depict the list in a drop-down menu or box in one example which is not shown). The user may select one or more of the data items which will thereafter be automatically launched when the user selects the respective tile which corresponds to interface 40. After the selection of the one or more data item(s) to be auto-launched, the user may select the save icon 54 to save the auto-launch selection. For example, a user may select a photograph data item and an audio file data item which are to be automatically launched and upon selection of the respective tile, the photograph would be displayed and the audio file played. A user may also specify that the data items be conveyed simultaneously or in a specified order upon being automatically launched in one embodiment.

Thereafter, when the user selects a tile which has a data item which was previously specified to auto-launch, the processing circuitry automatically conveys the appropriate data of the auto-launch data item to the user upon selection of the tile without display of the data view interface or additional user input which instructs the processing circuitry to initiate the conveyance of the data.

If the user has initiated the auto-launch feature for the respective data view interface 40, the default view icon 55 may be utilized to return the respective data vie interface 40 to the default mode wherein all of the data items are shown as depicted in the example of FIG. 5. In one embodiment, the appropriate icon 55, 56 which was selected by the user may be highlighted to indicate which mode (default or auto-launch) the given data view interface 40 is currently in.

Referring to FIG. 6, one possible method for a user to add a new tile to the GUI is described in one embodiment. The interface 60 may also be used to add new data items to an existing tile. In the described example, a user may utilize a blank tile (e.g., tile 35 of FIG. 3) mentioned above to add a new tile to the GUI. Alternatively, a user may select addition icon 50 of a tile being depicted in the data view interface 40 to add one or more new data items to the tile. Other methods are possible.

In one embodiment for adding a new tile, the user initiates an operation to add a tile at an appropriate hierarchical level by selecting a blank tile at the appropriate hierarchical level where the tile is to be added in the data organizational hierarchy. In one example, a user may select one of the blank tiles 35 shown in FIG. 4 to add a new sub-category tile to the second hierarchical level. A user is presented with an add tile interface 60 of FIG. 6 which assists the user with the addition of a new tile in one embodiment.

As shown, interface 60 includes the addition and control icons 50, 52 of FIG. 5 in one embodiment. Interface 60 includes a title field 62 where the user can define a title for the new tile. Upon initiation of interface 60, only the addition and control icons 50, 52 and title field 62 are initially presented to the user in one implementation (and accordingly icons 63, 65, 67, data fields 64, 66, 68 and icon 69 would not be displayed until they were added by the user as described below).

In one embodiment, the user may select another screen to define an image to be viewed as wallpaper for the tile being created. For example, the user may pan left or right to review a screen where an icon may be selected which causes images which are stored in the computing device to be listed for the user. The user may select a desired image as the wall paper for the tile being created. In another example, an icon may be presented which enables a user to draw doodle art upon a selected image or blank screen and which will be used as the background wallpaper.

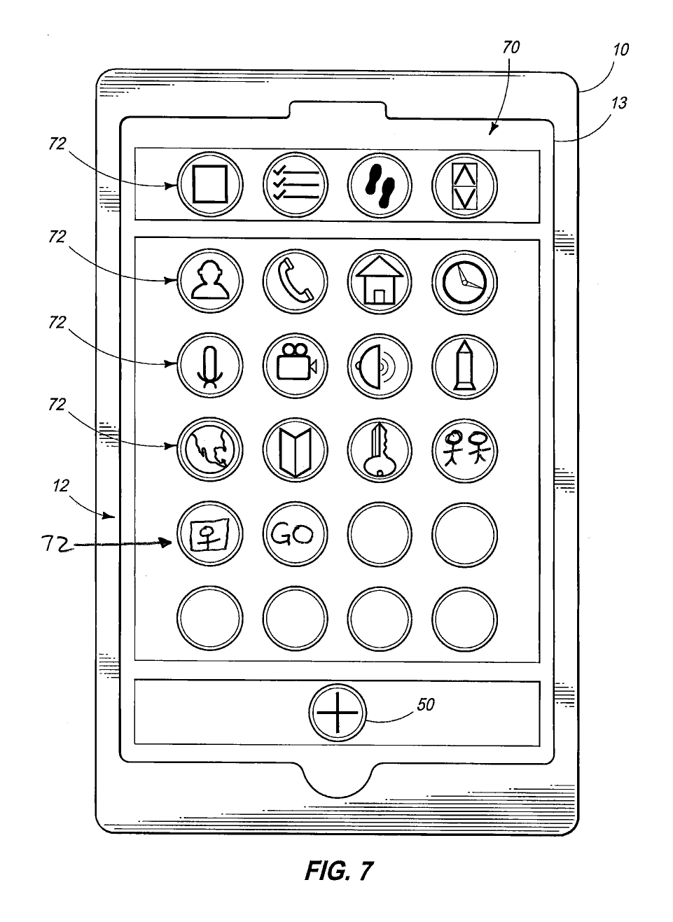

Following entry of the title into title field 62, the user may select the addition icon 50 to add a data item to the new tile. The computing device 10 presents the chose data interface 70 of FIG. 7 if the user selects the addition icon 50 of FIG. 6 in one embodiment.

Referring to FIG. 7, the chose data interface 70 includes a plurality of data type icons 72 which are arranged in an array. The icons 72 correspond to different types of data items and interface 70 enables the user to select the appropriate types of data items which will be included in the respective data view interface 60 being created. The user may select one or more of the icons to include a plurality of respective data items which correspond to the selected data types in the interface 60 being created in one embodiment. This described example enables the user to tailor the data view interface to include the data items and fields which are to be used without encumbering the interface with unused fields.

Starting in the upper left corner of FIG. 7 and proceeding to the right, the example depicted data type icons 72 which may be selected by a user include a text box icon, a check list icon, a steps icon, a counter icon, a name icon, a telephone number icon, an address icon, a date/time icon, an audio recording icon, a video file icon, an audio file icon, a launch program icon, a website icon, a pdf icon, a password icon, a collaboration icon, a photograph icon and a go icon. More, less and/or different icons may be utilized for other types of data items in other embodiments.

Example operations which may be performed when the data type icons 72 are selected by the user are described below. For example, following the selection of one or more of the data type icons 72 (which may be highlighted as they are selected), the appropriate data fields for the chosen data types are displayed in a data view interface, such as add data interface 60 shown in FIG. 6 in the order of selection by the user. The user thereafter further interacts with interface 60 to define the data in the data fields which correspond to the type of data items which were selected by the user as described in further detail below.

Following the selection of one or more of the appropriate data type icons 72, the user may select the addition icon 50 to finalize the selection and proceed to the add data interface 60 where data may be provided from the user to the respective data fields. The icons 72 selected by the user and respective data fields for each of the icons 72 are illustrated in the add data interface 60 following the selection of the addition icon 50 by the user.

If the text box icon is selected in interface 70 (i.e., the first data type icon 72 in the upper left corner), the user may enter data into a text data field when the data field for the text box icon is generated in interface 60 (e.g., an example data field generated for the text box icon is data field 48b of FIG. 5). If the checklist icon is selected, the user may enter a checklist to be subsequently “checked off” by the user into a checklist data field (e.g., data field 66 of FIG. 6). The user may enter a series of steps to be performed into a steps data field (not shown) if the steps icon is selected. A number counter may be generated in a number counter data field (not shown) which may be incremented or decremented by the user if the number counter icon is selected by the user in one embodiment. The user may enter the first and last name of an individual into a name data field (not shown) if the name icon is selected. The user may a phone number into a phone number data field (not shown) if the phone number icon is selected. The user may enter an address into an address data field (not shown) if the address icon is selected. The user may enter the date and time into a date and time data field (not shown) if the date and time icon is selected. The user may record an audio recording via a microphone of the computing device if the audio recording icon is selected. The user may attach a video file (e.g., MPEG-4, MPEG, AVI, WMV, etc.) by entering the location of the video file (internal file, website, etc) into a video attachment data field (e.g., data field 48a shown in FIG. 5) if the video file icon is selected. The user may attach an audio file (e.g., mp3, mp4, wma, etc.) by entering the location of the audio file (internal file, website, etc) into an audio attachment data field if the audio file icon is selected. The user may specify a program to be launched by identifying and/or entering the location of the program file (internal file, http link, website, etc.) into a program data field if the launch program icon is selected. The user may specify a website to be launched by entering the website into a website data field (e.g., data field 64 shown in FIG. 6) if the website icon is selected. The user may specify a pdf file to be presented by entering the location of the pdf file (internal file, website, etc.) into a pdf data field if the pdf icon is selected. The user may specify a password for the tile being created by entering the password into a password data field if the password icon is selected. Thereafter, a user wishing to view the respective tile (or any subordinate tiles thereunder) must provide the password in order to gain access to a password-protected tile. The collaboration icon is utilized by the user to define whether the tile may be modified by others who access the tile (e.g., accessed via the server 22, email, etc. as discussed in further detail below). If the user specifies that the tile is collaborative, then other users are authorized to modify the tile and if the tile is not specified as collaborative then the other users are not permitted to change the tile. The user may specify a photograph to be displayed by selecting the photograph icon and identifying the photograph to be displayed. The user may use the go icon to specify that the interface depict a tile which is different than a tile which was selected by the user during subsequent interaction. For example, each of the tiles, sub-ordinate tiles, sub-sub-ordinate tiles, etc. may be numbered and the user may provide a number in a data field which corresponds to the data item of the go icon, and which during subsequent interaction of the user selecting the tile having the go data item, automatically directs the user to another tile identified by the number which is in the data field of the go data item. Other icons may be defined and utilized for other data items in other embodiments.

In the depicted example of the add data interface 60 shown FIG. 6, the user first selected the website icon as indicated by the depiction of the website icon 63 and the website data field 64 immediately below the title field 62 in FIG. 6. The user thereafter selected the checklist icon and the audio file icon as represented by the checklist and audio icons 65, 67 and respective data fields 66, 68 being illustrated below the website data field 64. The user may thereafter enter appropriate data to the data fields 64, 66, 68 via interface 60. Furthermore, the user can attach the identified audio file (“rock.mp3”) in the illustrated example by selecting icon 69.

Following entry of the appropriate data in the data fields and the attachment of the appropriate files, the user may select the save icon 54 to save the data and the links to the attached files and thereby creating the tile for use and which may be accessed by the user during subsequent interaction with the levels of tiles. After the selection of the data type icons 72 for the data items for the tile, the providing of the data for the data fields for the data items, and saving the tile, the selected data type icons 72 (i.e., icons 63, 65, 67 in FIG. 5) may be displayed in the data view interface for the respective tile as data item icons which correspond to the types of data items, for example, as described above in FIG. 5 in one embodiment.

Thereafter, when the user selects the respective tile during interaction with the hierarchical levels of tiles, the user is presented with a data view interface (which corresponds to data view interface 40 with the data items and already-entered data present in the data fields) in one embodiment. Following accessing of the data view interface, a user may select one or more of the data items (e.g., by selecting one of the data item icons) to instruct the computing device to convey the data associated with the respective data item to the user. For example, the user may launch media by clicking on an icon if it is launchable media (e.g., launch the website specified in data field 64 by clicking on website icon 63). Other examples of launchable data icons include videos, audios, http links, programs including ordered executable instructions, pdfs, etc. The user may also read the text in textual data fields (e.g., checklist items, steps, text fields, etc.). Following completion of a task, the user may check the empty box in the data field 66 in one embodiment.

One or more of the data items (i.e., the icon and respective data field) may be deleted from the data view interface by selecting the appropriate icon and dragging it to the delete icon 57 whereupon the icon and respective data field are removed from the data view interface for the tile upon subsequent interactions of the user with the data view interface for the tile.

The user may add additional data items to an already-created tile by selecting the addition icon 50 (e.g., see FIG. 5) in one embodiment. The user may access the appropriate data view interface 40 for the appropriate tile, select the addition icon 50, and thereafter interact with the chose data interface 70 to add the additional data items similar to the procedure discussed above in one embodiment.

As mentioned previously, users may implement communications externally of their computing device 10. As discussed below, users may output and receive communications with respect to a server which may be accessed by other users, or may output and receive email communications with respect to other users in example embodiments. The user of a computing device 10 may output and/or receive tiles, subordinate tiles, and data items in one embodiment. Furthermore, a hierarchical arrangement of tiles, subordinate tiles and data items which are communicated may also be maintained during the communications to facilitate the organization of the data for the recipient as discussed below in some example embodiments.

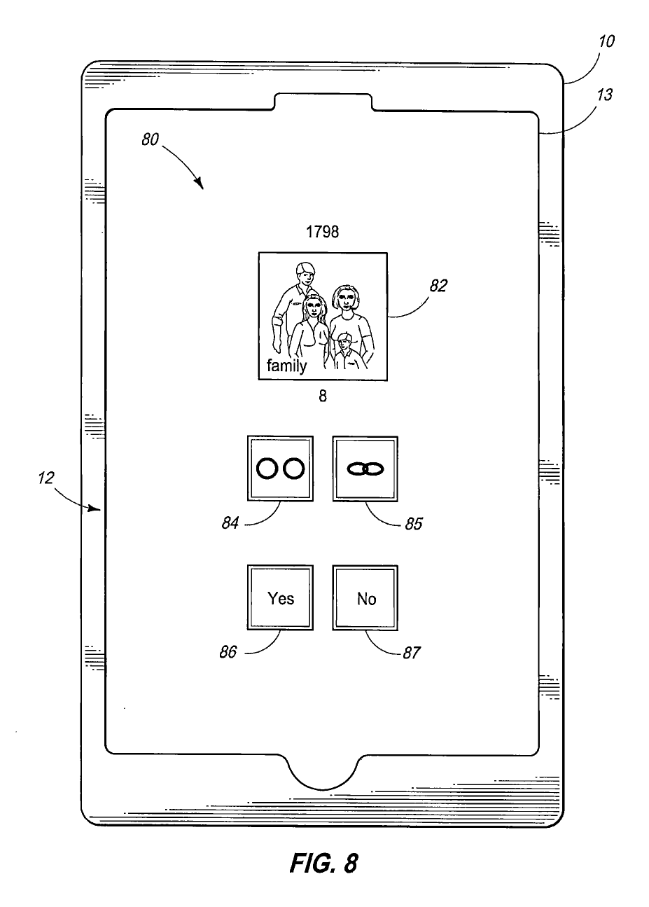

For example, users may upload information to a server 22 to be accessed by other users. Referring to FIG. 8, an example upload interface 80 is shown according to one embodiment and which may be utilized by a user to upload information from his computing device 10 to server 22. In one embodiment, the user may select one of the tiles 30, 34 from an appropriate hierarchical level by selecting the desired hierarchical level and selecting one of the displayed tiles 30, 34, for example, as shown in FIGS. 3 and 4. The user may drag the selected icon to the cloud icon 25 of the control icons 32 shown in FIGS. 3 and 4. In one embodiment, the selected tile and all subordinate tiles and data items thereof are also selected for external communication by the selection of the respective tile which simplifies the communication of the data. Thereafter, the computing device 10 generates the user interface 80 shown in FIG. 8 where the user may select options for the information to be uploaded to the server 22.

In one embodiment, the upload interface 80 displays the tile 82 which was selected by the user. In addition, the upload interface 80 includes control icons including non-linking and linking icons 84, 85 and yes/no icons 86, 87. If the user selects the linking icon 85, then the selected tile 82 to be uploaded to server 22 will be linked to the version of the tile 82 in the user's computing device 10. Any modifications to the selected tile 82 in the user's computing device 10 will be made to the tile 82 stored in the server 22. For example, following uploading of the tile 82 to the server 22, if the user adds or deletes a data item of the tile 82, then the added or deleted data item change would also be made to the tile 82 stored in server 22.

In one embodiment, all sub-ordinates tiles below the selected tile 82 (e.g., tiles associated with the selected tile 82 but at lower hierarchical levels) and their respective data items may also be automatically uploaded to the server 22 when the user uploads the tile 82. Accordingly, if the user subsequently adds or deletes a sub-ordinate tile, the addition or deletion of the sub-ordinate tile (and respective data items thereof) also occurs in the information stored in the server 22. In one embodiment, the modifications of the linked tiles are made automatically without user input. For example, the modifications made to the tile 82 by the user on his computing device 10 will be automatically made to the tile 82 stored in the server 22 without instruction from the user specifying for the change to be made in the version stored on the server 22 in one embodiment. In one embodiment, changes made to the user's tile, subordinate tiles or data items by other recipients may also be automatically updated in the computing device of the user who uploaded the tile, subordinate tiles or data items if the linking option is used and the user specified that the uploaded tile is to be collaborative as discussed above with respect to the chose data interface 70.

Alternatively, the user may select non-linking icon 84 after selection of the tile 82 and no modifications which occur to the tile 82 stored in the computing device 10 will be automatically made or updated to the corresponding tile stored in the server 22 in one embodiment.

Following the selection of the tile 82, and the specification of whether the tile 82 is to be linked or not, the user may select the yes icon 86 to upload the tile 82 to the server 22. Other users may access the uploaded tiles 84 via accessing the server 22 in one embodiment. Alternatively, the user may select the no icon 87 to not upload the tile 82 and the tile 82 is not uploaded.

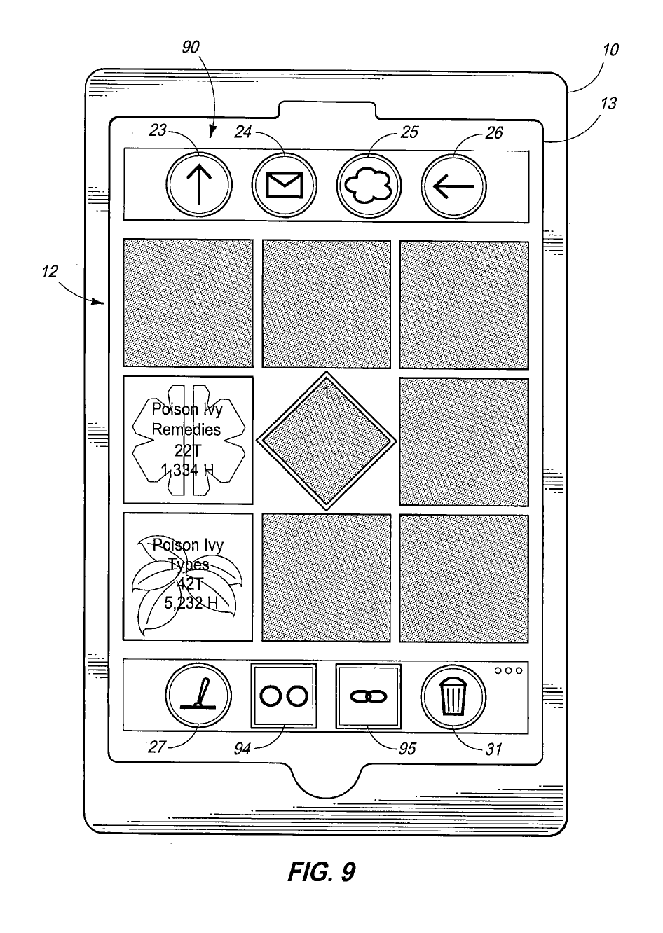

Referring to FIG. 9, one embodiment for downloading information from the server 22 to a computing device 10 is described with respect to a search interface 90. In one implementation, the user may select the cloud icon 25 which results in the presentation of a text box via the interface 12 (not shown). The user may type in a search string using the text box. In the illustrated example, a user inputted “poison ivy” and the display 13 depicts the search result tiles 92. The search string entered by the user may be uploaded to the server 22 and used by the server 22 to search tiles of other users which were previously uploaded. The server 22 may communicate the search result tiles 92 which matched the search string to the computing device 10. The search result tiles 92 may include additional indicia, such as the number of sub-ordinate tiles associated with the respective tile (e.g., 22 Tiles or 42 Tiles) and the number of times the respective tile was previously found in prior searches (e.g., 1,334 Hits or 5,232 Hits).

The user may thereafter select one of the search result tiles 92 and drag the selected tile 92 to one of the control icons 94, 95. The user may drag the selected tile 92 to the non-linked icon 94 if the user wishes to have the selected tile 92 which will be downloaded to his computing device 10 not linked to receive updates which are thereafter made to the version of the selected tile 92 stored on server 22. Alternatively, the user may drag the selected tile 92 to the linking icon 95 if the user wishes to have the downloaded tile 92 linked to updates which are made to the version of the selected tile 92 in the server 22 (if the selected tile is linked to the computing device 10 of the author who created the tile). The selected tile 92 may replace either of the icons 94, 95 following the dragging of the tile 92 to the respective icon 94, 95. The user may modify the downloaded tile if the tile was specified as a collaborative tile as discussed above in one embodiment.

Thereafter, the user may select the up-arrow 23 to return to the highest hierarchical level of tiles 30 shown in FIG. 3. The user may then utilize the interface 12 to select the desired category and hierarchical level to which the tile 92 will be applied to the user's hierarchal arrangement of tiles. Once the user 12 depicts the desired hierarchical level under the desired category, the user may drag the tile from the appropriate icon 94 or 95 to the desired position on the tile grid of the hierarchical level being displayed. In one embodiment, all of the sub-ordinate tiles of the selected tile 92 are also downloaded to the computing device 10 and incorporated within the user's hierarchy of tiles.

The user may also email tiles and respective data items thereof using computing device 10 in one embodiment. In one implementation, the user may select a tile from one of the hierarchical levels of his personal grid of tiles, for example shown in FIG. 3 or 4, and drag the selected tile to the email icon 24. Thereafter, the computing device 10 generates an email, attaches the selected tile, sub-ordinate tiles, and data items thereof as an attachment to the opened email. The user may enter the appropriate information for the email and send the email to a desired address. In one embodiment, the selected tile, sub-ordinate tiles, and data items may be attached as CSS data.

Furthermore, users of the computing device 10 may receive emails from other users which include one or more tiles, sub-ordinate tiles, and/or data items. In one embodiment, the user may click on the attachment to the email which results in the generation of a user interface, similar to FIG. 3, which includes the tile of the highest level in the attachment. The user may select the tile to review the sub-ordinate tiles and/or data items associated with the tile.

The user may add the tile to one of the hierarchical levels in his personal grid of tiles by selecting the displayed tile and moving the tile to one of the linked or copy icons 28, 29 (e.g., FIG. 3 or 4) whereupon the respective icon 28 or 29 becomes the image of the tile. Thereafter, the user may select the icons 23, 26 or control tile 33 to view his personal grid of tiles, navigate his personal grid of tiles to locate an appropriate category and hierarchical level for the received tiles and data items, and thereafter move the tile from the respective icon 28 or 29 to a blank tile upon the appropriate hierarchical level and category of the user's personal grid of tiles which correspond to the subject matter of the selected tile in one embodiment and which may thereafter accessed by the user when the respective category and hierarchical level is viewed by the user. The tile including the image and identifying indicia and respective data items and perhaps sub-ordinate tiles may now be located by navigating through the user's personal grid of tiles.

The attached tiles and data items will be updated with changes made by the creator of the tiles if the user moves the tile to linked icon 28. Alternatively, the user may drag the selected tile to copy icon 29 if the user only wishes to copy the attached tiles and data items to the user's personal grid of hierarchical levels of tiles without future updating. The user may modify the attached tiles if the tiles were specified as a collaborative tiles as discussed above.

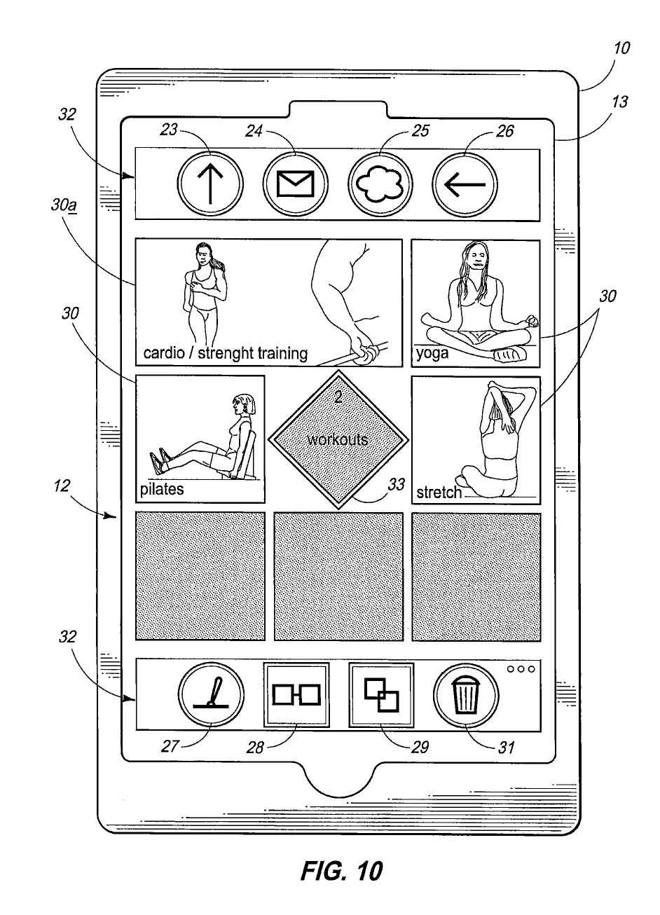

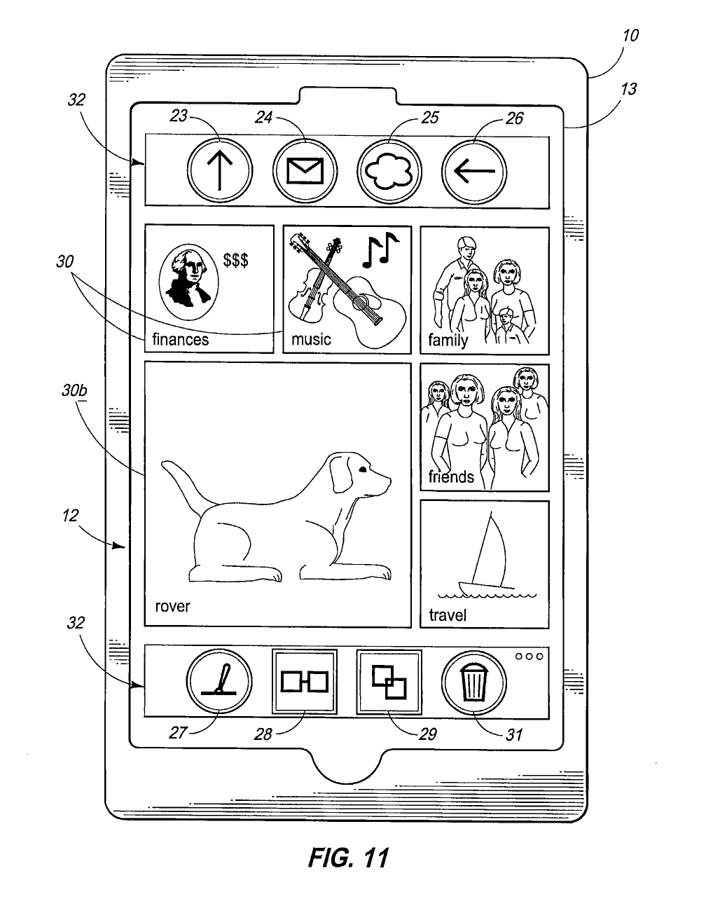

Referring to FIGS. 10 and 11, a user may modify tiles which are depicted at one or more of the hierarchical levels of the graphical user interface according to one embodiment. FIG. 10 illustrates one example where two tiles of a given hierarchical level are combined (the combined tiles are at the second hierarchical level in the illustrated example although tiles of other levels can be combined by a user). FIG. 11 illustrates one example where one tile of a given hierarchical level has an increased size (the enlarged tile is shown at a first hierarchical level although tiles of other levels can also be enlarged by a user).

Referring to FIG. 10, a user has combined or glued two tiles 30 (which previously corresponded to “cardio” and “strength training”) together to form a composite tile 30a which may be larger in size as shown in the depicted example. In one embodiment, the user can place a thumb and index finger on the two tiles 30 to be combined and pinch the thumb and index finger together to form the composite tile 30a. Other methods for combining tiles may be used in other embodiments.

The subordinate tiles and data items which are associated with the tiles which are combined are also combined in one embodiment. Accordingly, the combined subordinate tiles and data items may be displayed in additional hierarchical levels if tile 30a is selected by a user. In addition, the composite tile 30a may have a larger size and include a larger image than the other tiles 30 in one embodiment.

A user may subsequently decide to unglue the composite tile 30a by pulling the composite tile 30a apart by placing his thumb and index finger on the tile 30a and moving his thumb and index finger apart. The original hierarchical arrangement of subordinate tiles and data items of the tiles 30 which were combined tiles may be utilized to divide the subordinate tiles and data items into the appropriate ones of the subsequently formed tiles 30 which may thereafter be independently interacted with by a user in one embodiment.

Referring to FIG. 11, a user has enlarged the small “rover” tile of FIG. 3 to an enlarged tile 30b. For example, a user may decide to enlarge a frequently used tile for ease of access or increased prominence. Enlargement of the tile 30b may increase the size of the tile and the image associated with the tile in one implementation. In one embodiment, a user may place two fingers on the tile to be enlarged and drag the finger which is positioned closest to the center of the tiles closer to the center which operates to enlarge the tile. The enlarged tile 30b behaves similarly to the smaller tiles 30 in one embodiment and a user may access data items or subordinate tiles of the tile 30b or add new data items to the tile 30b.

A user may reduce the size of an enlarged tile 30b by placing one finger on the corner of the tile 30b closest to the center of the tiles and another finger on the opposite corner of the tile 30b and pinching their fingers together in one embodiment. The tiles 30 which were covered by the larger tile 30b are shown once again following the reduction in size of the enlarged tile 30b and may be interacted with by the user if desired.

Although some embodiments of the disclosure are described with respect to touch screen interfaces which are configured to interact with users inputs via the display, other interface configurations may be utilized, such as separate keyboards, pointing devices, scrolling devices, input pad devices, or any other suitable interfaces which permit a user to interact with the graphical user interface.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. A computing device comprising:
a display configured to generate visual images;
processing circuitry coupled with the display and configured to control the display to depict a graphical user interface which comprises a plurality of tiles of a first hierarchical level, to access user input selecting one of the tiles of the first hierarchical level which are displayed in the graphical user interface, and to control the display to depict the graphical user interface comprising a plurality of tiles of a second hierarchical level which are associated with the selected one of the tiles of the first hierarchical level as a result of the accessed user input selecting the one of the tiles of the first hierarchical level; and
wherein a plurality of different data items are associated with individual ones of the tiles of the second hierarchical level and wherein the processing circuitry is configured to control the computing device to convey data of one of the data items to a user of the computing device.

2. The device of claim 1 further comprising storage circuitry which is configured to store the plurality of data items which are associated with the one of the tiles of the second hierarchical level.

3. The device of claim 1 wherein the data items associated with one of the tiles of the second hierarchical level are different types of media which may be experienced by the user.

4. The device of claim 1 wherein the processing circuitry is configured to control the computing device to convey the data as a result of accessing user input which selects one of the tiles of the second hierarchical level which is associated with the data of the one of the data items.

5. The device of claim 4 wherein the processing circuitry is configured to automatically initiate the conveyance of the data of the one of the data items as a result of the user input selecting the one of the tiles of the second hierarchical level and without additional user input which instructs the processing circuitry to initiate the conveyance of the data.

6. The device of claim 4 wherein the processing circuitry is configured to control the display to depict the plurality of data items which are associated with the one of the tiles of the second hierarchical level as a result of the user input selecting the one of the tiles of the second hierarchical level and to control the computing device to convey the data of one of the data items as a result of accessing user input which selects the one of the displayed data items.

7. The device of claim 1 wherein the processing circuitry is configured to control the display to depict the tiles of one of the first and second hierarchical levels in a plurality of different sizes.

8. The device of claim 1 wherein the processing circuitry is configured to combine the data items of plural ones of the tiles of the second hierarchical level as a result of user input combining the plural ones of the tiles of the second hierarchical level.

9. The device of claim 1 wherein the tiles of the first hierarchical level are displayed in a grid which utilizes a majority of a display surface of the display.

10. The device of claim 1 wherein the graphical user interface includes a level indicator which indicates the hierarchical level of tiles which is depicted using the display at a respective moment in time.

11. The device of claim 1 wherein the processing circuitry is configured to depict a data view screen which includes the data items which are associated with one of the tiles of the second hierarchical level as a result of user input selecting the one of the tiles of the second hierarchical level.

12. A computing device comprising:
a display configured to generate visual images;
communications circuitry configured to implement communications externally of the computing device;
processing circuitry coupled with the display and the communications circuitry, and wherein the processing circuitry is configured to control the display to depict a graphical user interface which comprises a plurality of tiles at a first hierarchical level, a plurality of tiles at a second hierarchical level which are associated with the tiles of the first hierarchical level, and a plurality of data items which are associated with the tiles of the second hierarchical level; and
wherein the processing circuitry is configured to control the communications circuitry to communicate, externally of the computing device, one of the tiles of the first hierarchical level, the tiles of the second hierarchical level which are associated with the one of the tiles of the first hierarchical level, and the data items which are associated with the tiles of the second hierarchical level which are associated with the one of the tiles of the first hierarchical level.

13. The device of claim 12 wherein the processing circuitry is configured to control the communications circuitry to communicate the one of the of the tiles of the first hierarchical level, the tiles of the second hierarchical level which are associated with the one of the tiles of the first hierarchical level, and the data items which are associated with the tiles of the second hierarchical level which are associated with the one of the tiles of the first hierarchical level to a server to be accessed by other users.

14. The device of claim 13 wherein the processing circuitry is configured to control the communications circuitry to communicate a password to the server and which is utilized by other users to access the one of the tiles of the first hierarchical level, the tiles of the second hierarchical level which are associated with the one of the tiles of the first hierarchical level, and the data items which are associated with the tiles of the second hierarchical level which are associated with the one of the tiles of the first hierarchical level.

15. The device of claim 12 wherein the processing circuitry is configured to control the communications circuitry to communicate the one of the tiles of the first hierarchical level, the tiles of the second hierarchical level which are associated with the one of the tiles of the first hierarchical level, and the data items which are associated with the tiles of the second hierarchical level which are associated with the one of the tiles of the first hierarchical level in a single email communication.

16. The device of claim 12 wherein the processing circuitry is configured to control the communications circuitry to communicate the one of the tiles of the first hierarchical level, the tiles of the second hierarchical level which are associated with the one of the tiles of the first hierarchical level, and the data items which are associated with the tiles of the second hierarchical level which are associated with the one of the tiles of the first hierarchical level as a result of user input selecting the one of the tiles of the first hierarchical level for external communication.

17. The device of claim 12 wherein the processing circuitry is configured to access user input selecting another of the tiles of the first hierarchical level, and to control the display to depict the tiles of the second hierarchical level which are associated with the another of the tiles of the first hierarchical level as a result of accessing user input selecting the another of the tiles of the first hierarchical level.

18. An article of manufacture comprising:
computer-readable storage media storing programming configured to cause processing circuitry to perform processing comprising:
displaying a plurality of data type icons of a graphical user interface and which are indicative of different types of data items;
as a result of user input, selecting one of the data type icons for a data item being created by a user;
associating data inputted by a user with the data item being created;
storing the data and the selected one of the data type icons of the data item; and
displaying the data and the one of the data type icons of the data item as a result of the user selecting one of a plurality of tiles of the graphical user interface.

19. The article of claim 18 wherein the programming is configured to cause processing circuitry to perform processing comprising:
displaying the graphical user interface comprising a plurality of the tiles of a first hierarchical level;
displaying the graphical user interface comprising a plurality of the tiles of a second hierarchical level as a result of user input selecting one of the tiles of the first hierarchical level; and
displaying a data view screen comprising the data and the data type icon of the data item as a result of user input selecting one of the tiles of the second hierarchical level which is associated with the data view screen.

20. The article of claim 19 wherein the programming is configured to cause processing circuitry to perform processing comprising displaying the data view screen comprising a plurality of additional data items.
